(19) United States
(12) Patent Application Publication
(10) Pub. No.: US 2006/0163434 A1
(43) Pub. Date: Jul. 27, 2006

(54) Spacecraft for interplanetary/lunar travel

(75) Inventors: Vipul P. Patel, Irvine, CA (US); Al MacKnight, Lakewood, CA (US); Alex M. Lubman, Redondo Beach, CA (US)

Correspondence Address: Honeywell International, Inc., Law Dept. AB2, P.O. Box 2245, Morristown, NJ, 07962-9806, US

(73) Assignee: Honeywell International Inc., Law Dept., Morristown, NJ (US)

(21) Appl. No.: 11/045,461

(22) Filed: Jan. 27, 2005

(51) Int. Cl. B64G 1/00

(52) U.S. Cl. 244/158.3; 244/171.9

(57) ABSTRACT

A self-propelled spacecraft may provide an artificial gravity environment for interplanetary and/or lunar travel. The spacecraft may be useful not only for interplanetary and/or lunar mission travel, but also for carrying supplies to space habitats, such as lunar habitats, and also for general exploration of space, including study of distant planets and stars. The spacecraft may travel on excursions of extended duration and of great distances, such as, for example to Mars or beyond. The spacecraft may provide an environment that ensures crew comfort for such extended interplanetary and/or lunar travel.

### BACKGROUND OF THE INVENTION

The present invention generally relates to spacecraft for interplanetary and/or lunar travel and, more specifically, to an inflatable artificial gravity spacecraft having an integrated propulsion mechanism therein.

Travel to different planets may take extended periods of time. For example, it may take 3 to 4 weeks for lunar travel, and as much as 18 months for travel to Mars and back. For the comfort of the crew, it may often be desirable to simulate normal Earth gravity conditions, especially for long interplanetary and/or lunar excursions.

U.S. Pat. No. 3,144,219 to Schnitzer describes a planetary orbital space station or space laboratory capable of being completely foldably or collapsibly stored in the payload stage of a launch vehicle. The orbital space station disclosed by Schnitzer is capable of rotation to create an artificial gravity environment. The space station described in the '219 patent may be launched into a planetary orbit and then self-erected into its operation configuration. The '219 patent does not provide any specific means for the space station to travel once launched into its planetary orbit.

U.S. Pat. No. 4,730,797 to Minovitch describes an orbital structure and space station that may be deployed in orbit. The space station disclosed in the '797 patent is a large permanently manned orbiting space station that provides an artificial gravity environment. The '797 space station is not designed for interplanetary travel and no means for such travel is disclosed.

As can be seen, there is a need for an improved spacecraft that provides an artificial gravity environment and is capable of interplanetary and/or lunar travel.

### SUMMARY OF THE INVENTION

In one aspect of the present invention, a spacecraft comprises a habitat module capable of rotating to provide an artificial gravity environment and a propulsion module capable of propelling the spacecraft through space.

In another aspect of the present invention, a spacecraft comprises an inflatable habitat module capable of rotating to provide an artificial gravity environment; a propulsion module capable of propelling the spacecraft through space; and a storage module, wherein the storage module and the propulsion module are contained in a center core of the spacecraft.

In yet another aspect of the present invention, a spacecraft for traveling through space comprises an inflatable habitat module capable of rotating to provide an artificial gravity environment; a propulsion module capable of propelling the spacecraft through space; a storage module, wherein the storage module and the propulsion module are contained in a center core of the spacecraft; at least one radiator capable of radiating waste heat from the spacecraft; at least one solar panel capable of collecting solar energy; and at least three attitude thrusters capable of adjusting an attitude of the habitat module.

In a further aspect of the present invention, a spacecraft comprises an inflatable habitat module capable of rotating to provide an artificial gravity environment; a propulsion module capable of propelling the spacecraft through space; and a storage module, the propulsion module is located on a plane parallel to a circumferential plane of the habitat module.

In still a further aspect of the present invention, a method for space travel in a spacecraft comprises providing an artificial gravity environment by rotating a habitat module at a velocity sufficient to create a gravitational force similar to a gravitational force on Earth; and propelling the spacecraft through space with a propulsion module.

These and other features, aspects and advantages of the present invention will become better understood with reference to the following drawings, description and claims.

### BRIEF DESCRIPTION OF THE DRAWINGS

FIG. 1 is a partially cut away side view of a spacecraft according to one embodiment of the present invention;

FIG. 2 is a plan view of the spacecraft of FIG. 1;

FIG. 3 is a schematic side-view representation of a spacecraft according to another embodiment of the present invention;

FIG. 4 is a schematic plan-view representation of the spacecraft of FIG. 3;

FIG. 5 is a schematic plan-view representation of the inflatable habitat usable in the spacecraft of the present invention; and

FIG. 6 is flowchart showing a method for providing for space travel in an artificial gravity environment according to an embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention provides a spacecraft that may provide an artificial gravity environment for interplanetary and/or lunar travel. The spacecraft of the present invention may be useful not only for interplanetary and/or lunar mission travel, but also for carrying supplies to space habitats, such as lunar habitats, and also for general exploration of space, including study of distant planets and stars. However, it should be understood that the present invention may be used in environments other than space, such as high altitudes.

Unlike conventional spacecraft, the present invention may provide not only an artificial gravity environment, but also a means of propulsion, thereby permitting the spacecraft of the present invention to travel on excursions of extended duration and of great distances. For example, a round trip to Mars may take upwards of 18 months for completion. The spacecraft of the present invention provides an environment that may ensure crew comfort for such extended interplanetary and/or lunar travel. Conventional artificial gravity space modules are often deployed in a particular orbit and remain in that orbit without means for propulsion to travel to other regions in space.

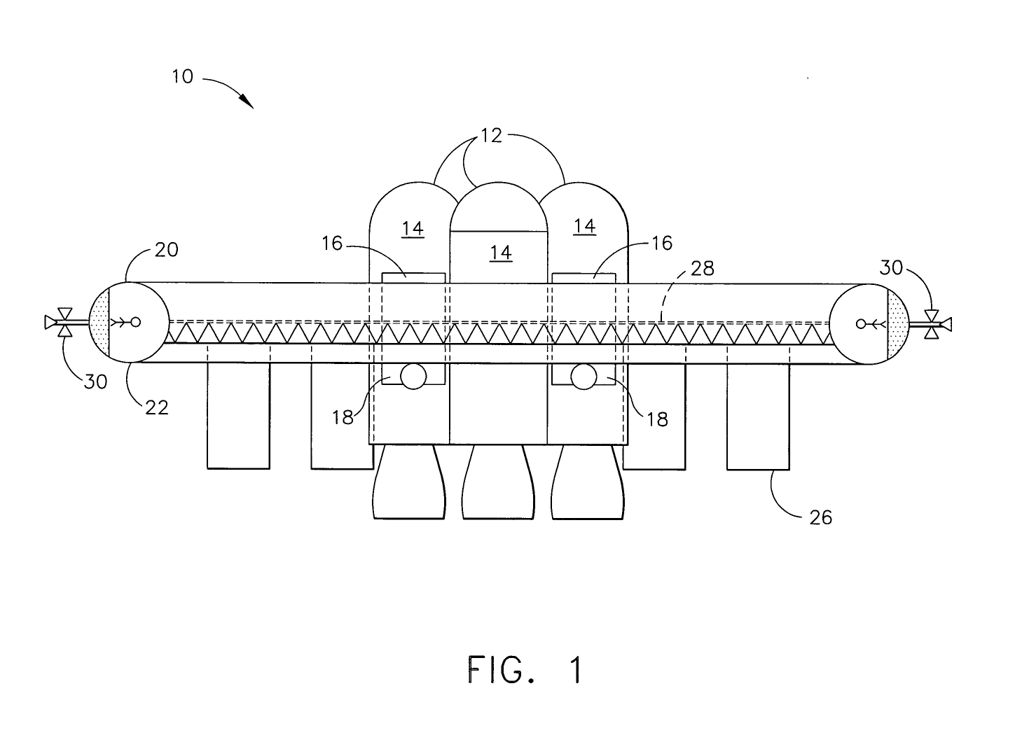

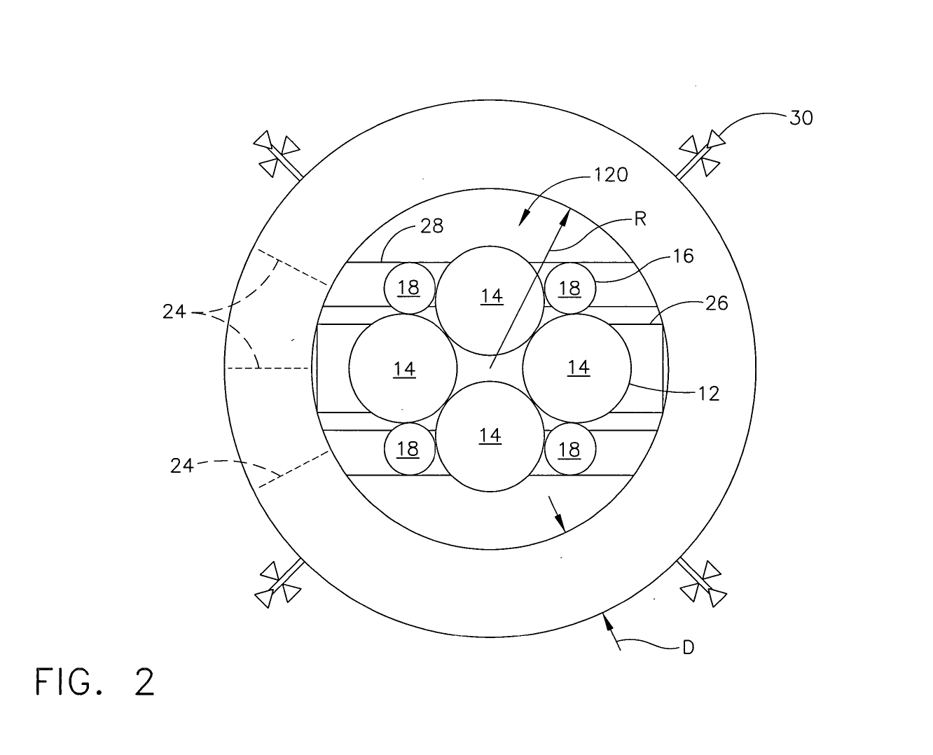

Referring to FIGS. 1 and 2, there are shown a partially cut away side view and a plan view, respectively, of a spacecraft 10 according to one embodiment of the present invention. Spacecraft 10 may have a center core propulsion system 12 comprising at least one propulsion module 14 for providing thrust for transit flights (interplanetary and/or lunar travel). In one embodiment of the present invention, center core propulsion system 12 may comprise four propulsion modules 14. Propulsion module 14 may be any conventional design usable for space travel.

Spacecraft 10 may also include a center core storage system 16 comprising at least one storage module 18. In one embodiment of the present invention, center core storage system 16 may comprise four storage modules 18. Storage modules 18 may be used, for example, to store fuel, water, gases (N₂ and O₂) and the like. Center core storage system 16 and center core propulsion system 12 may each be stored in a center core 120 of habitat module 22.

Spacecraft 10 may have an annular pressurized section 20 that may form habitat module 22. Habitat module 22 may be made of circular cross-section elements made from inflatable structures with multiple nodes 24 to form a complete tubular annulus. Nodes 24 may provide isolation of the personnel volumes, vehicle control and communication center, environmental control and life support systems (ECLSS), extravehicular activity (EVA) airlock, docking functions and the like. Habitat module 22 may rotate at a rotational velocity between about 10 to about 15 revolutions per minute, for example, about 10 revolutions per minute, to provide a gravitational force therein approximately equal to Earth's gravitational force. Habitat module 22 may have an internal diameter D from about 10 feet to about 30 feet. In one embodiment, habitat module 22 may have an internal diameter D of about 20 feet. Habitat module 22 may have an annular inner radius R from about 40 to about 80 feet. In one embodiment, annular inner radius R may be about 60 feet.

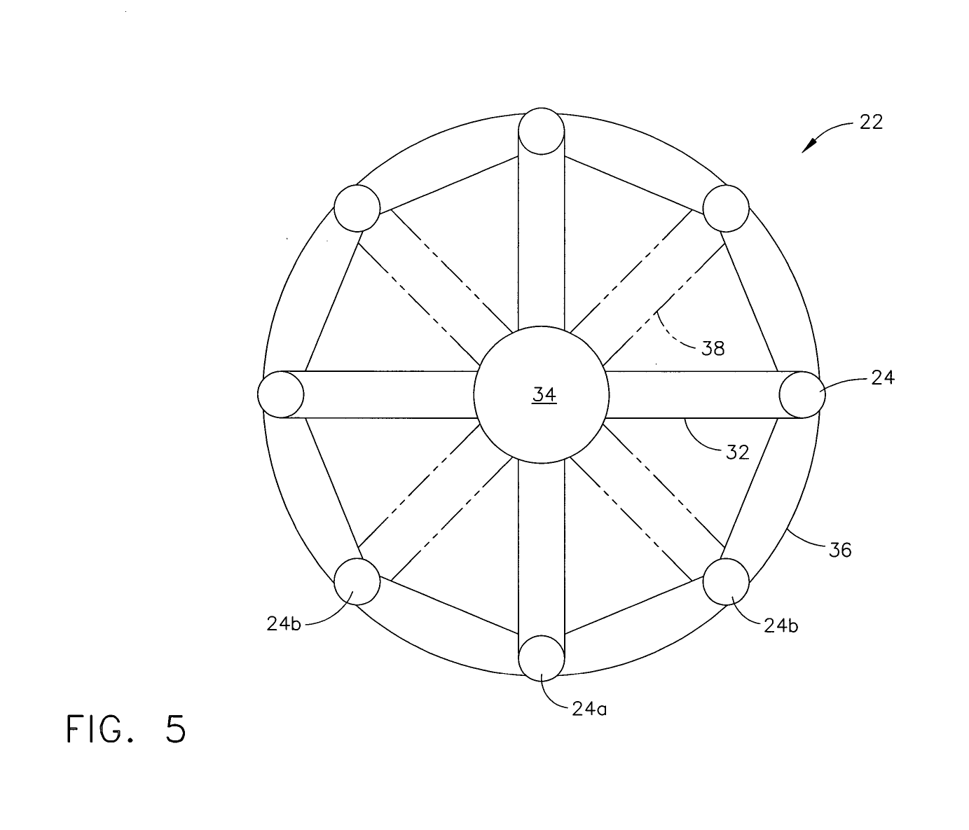

Referring also to FIG. 5, there is shown a schematic plan-view representation of habitat module 22 usable in the spacecraft 10 of the present invention. In this particular embodiment, eight nodes 24 may separate habitat module 22 into a plurality of inflatable habitat segments 36. A plurality of inflatable passage ways 32 may connect certain nodes 24 with a center core region 34 of habitat module 22. A plurality of structural support members 38 may connect certain other nodes 24 with center core region 34. In one embodiment, as shown in FIG. 5, one node 24a may have inflatable passage way 32 connecting that node 24a with center core region 34, while adjacent nodes 24b may have structural support members 38 connecting those nodes 24b with center core region 34.

Spacecraft 10 may have at least one radiator 26 for radiating waste heat from spacecraft 10. Radiator 26 may be, for example, an optical radiator, as is known in the art. Radiator 26 may be oriented away from the sun to maximize heat output.

Spacecraft 10 may be powered by solar energy, fuel, nuclear energy, or combinations thereof. For example, spacecraft 10 may include solar panels 28 to provide power for the ECLSS (not shown), including a distributed environmental control system (ECS, not shown). As a non-limiting example, solar panels 28 may be disposed on an external surface of one or more modules of spacecraft 10, such as on habitat module 22. Solar panels 28 may be oriented to receive the sun's rays in order to maximize solar energy collection. Solar panels 28 may be positionally adjustable by any means known in the art.

Fuel may be kept in at least a portion of storage module 16 for attitude thrusters 30. At least three attitude thrusters 30 may be provided for attitude adjustment of spacecraft 10. In one embodiment of the present invention, four attitude thrusters 30 are provided. Attitude thrusters 30 may be mounted on the outer circumference of habitat module 22 and may be capable of adjusting an attitude of habitat module 22.

Spacecraft 10 may be launched as separate modules from Earth, and the modules may be assembled in space. Any conventional means may be used to launch spacecraft 10 and assemble the components of spacecraft 10. For example, U.S. Pat. Nos. 4,730,797 and 6,547,189 disclose inflatable structures, such as space stations, that may be assembled in space.

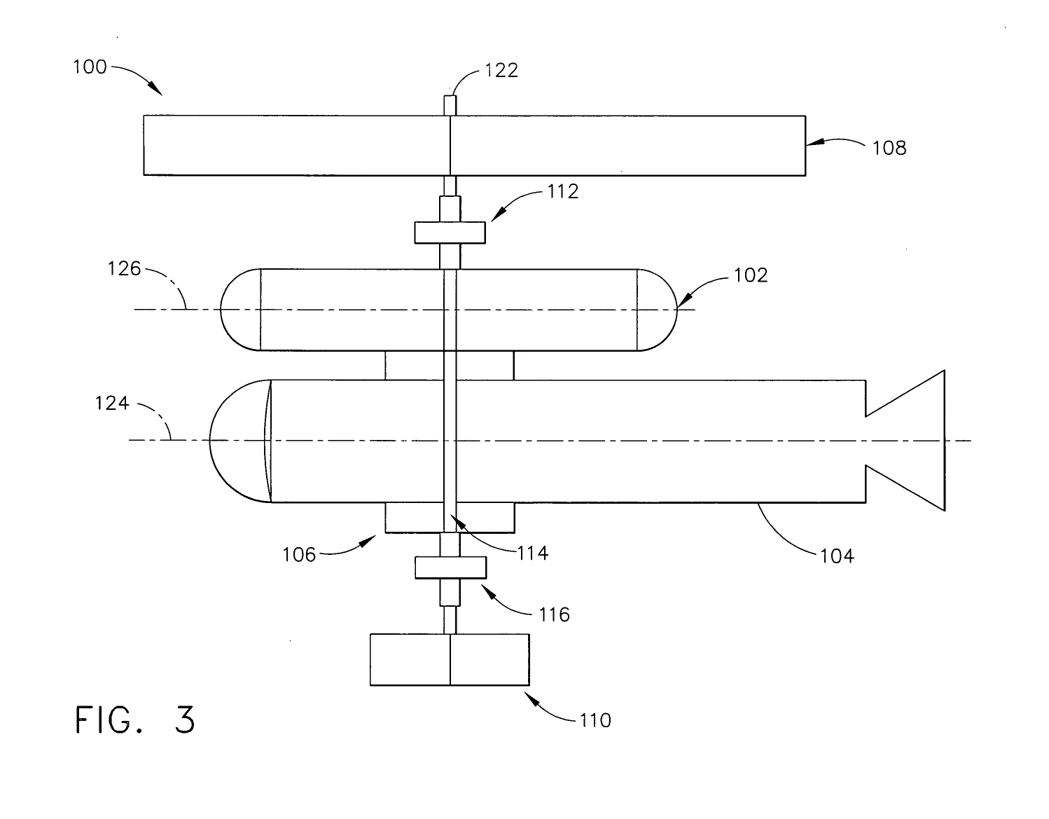

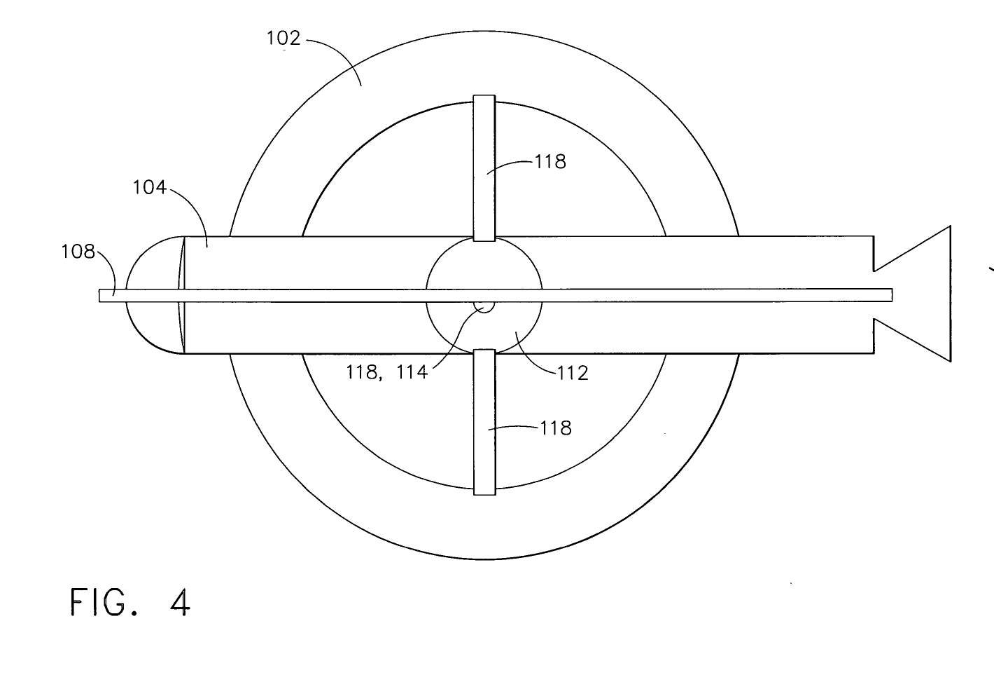

While the above description referred to a spacecraft 10 having a center core region 120 containing propulsion modules 14 and storage modules 18, other configurations may be contemplated within the scope of the present invention. Referring now to FIGS. 3 and 4, there are shown a schematic side view and a plan view, respectively, of a spacecraft 100 according to another embodiment of the present invention. Spacecraft 100 may have similar features as spacecraft 10. For example, spacecraft 100 may include a rotating habitat 102, propulsion module 104, storage area 106, solar panels 108 and radiator panels 110. In this embodiment of the present invention, propulsion module 104 may be located on a plane 124 about parallel to a circumferential plane 126 of rotating habitat 102. This configuration may provide thrust from propulsion module 104 in a direction substantially perpendicular to a rotational axis 122 of rotating habitat 102.

Spacecraft 100 may also include at least one docking port 112 for allowing spacecraft 100 to dock with, for example, permanently orbiting satellites, to receive supplies or to make repairs in space. Spacecraft 100 may also include a vehicle module 116 for storing, for example, a crew escape vehicle (not shown) or a planetary landing vehicle (not shown).

Spacecraft 100 may also include an elevator shaft 114 connecting rotating habitat 102 with the other components of spacecraft 100. In one embodiment, elevator shaft 114 may be positioned at a central rotational axis 122 of rotating habitat 102. A bridge 118 may connect rotating habitat 102 with elevator shaft 114.

The spacecraft of the present invention may be useful for interplanetary and/or lunar mission travel. The concept of a rotating spacecraft to provide artificial gravity is very attractive for crew health and ECLSS systems operations, because a gravity similar to Earth's gravity may be important for crew health and physiology. The spacecraft of the present invention may also be useful to provide supplies to future lunar habitats or to manned spacestations. Further, because the artificial gravity environment provided by the present invention may provide a physiologically healthful environment for the crew, further manned exploration of space to Mars and beyond may be possible.

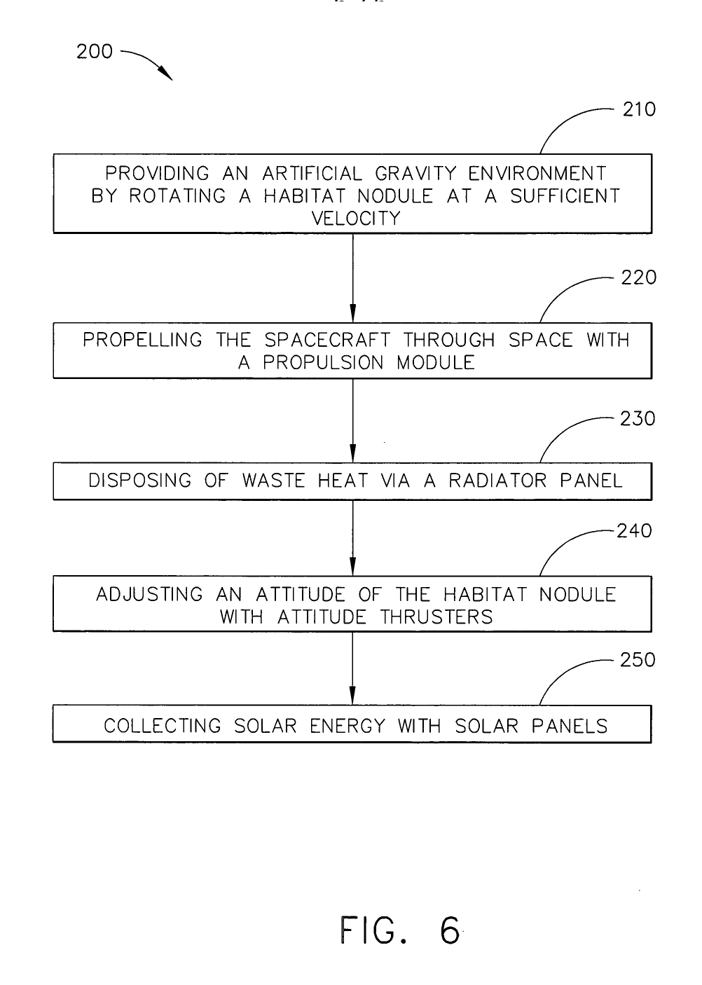

Referring to FIG. 6, there is shown a flow chart representing a method 200 for travel through space in an artificial gravity environment. Step 210 may provide the artificial gravity environment by rotating a habitat module at a sufficient velocity. This velocity may be from about 10 to about 15 revolutions per minute. Step 220 may propel the spacecraft through space via a propulsion module. Step 230 allows for the dissipation of heat from the spacecraft via a radiator panel. Step 240 allows for attitude adjustment of the spacecraft by using attitude thrusters. At least three attitude thrusters may be provided on an outer circumference of the habitat module to provide adequate attitude adjustment. Step 250 allows for the collection of solar energy through spacecraft mounted solar panels.

It should be understood, of course, that the foregoing relates to exemplary embodiments of the invention and that modifications may be made without departing from the spirit and scope of the invention as set forth in the following claims.

1. A vehicle comprising:
a habitat module capable of rotating to provide an artificial gravity environment; and
a propulsion module capable of propelling the vehicle.

2. The vehicle according to claim 1, wherein the habitat module comprises a pressurized inflatable tubular annulus.

3. The vehicle according to claim 1, wherein the habitat module has an internal diameter of about 10 to about 30 feet.

4. The vehicle according to claim 1, wherein the habitat module is capable of rotating at about 10 to about 15 revolutions per minute.

5. The vehicle according to claim 1, further comprising a storage module mounted within the vehicle.

6. The vehicle according to claim 5, wherein the storage module and the propulsion module are contained in a center core of the vehicle.

7. The vehicle according to claim 1, wherein the propulsion module is located on a plane parallel to a circumferential plane of the habitat module.

8. The vehicle according to claim 6, wherein the center core has a radius of about 40 to about 80 feet.

9. The vehicle according to claim 1, further comprising at least one radiator capable of radiating waste heat from the vehicle.

10. The vehicle according to claim 1, further comprising at least one solar panel mounted to the vehicle capable of collecting solar energy.

11. The vehicle according to claim 1, further comprising at least three attitude thrusters capable of adjusting an attitude of the habitat module.

12. The vehicle according to claim 11, wherein the attitude thrusters are disposed on an outer circumference of the habitat module.

13. The vehicle according to claim 1, further comprising a docking port for docking the vehicle to other space structures.

14. The vehicle according to claim 1, further comprising a vehicle module within the vehicle for storing a crew escape vehicle or a planetary landing vehicle.

15. A spacecraft comprising:
an inflatable habitat module capable of rotating to provide an artificial gravity environment;
a propulsion module capable of propelling the spacecraft through space; and
a storage module,
wherein the storage module and the propulsion module are contained in a center core of the spacecraft.

16. The spacecraft according to claim 15, wherein:
the habitat module has an internal diameter of about 10 to about 30 feet; and the center core has a radius of about 40 to about 80 feet.

17. The spacecraft according to claim 15, wherein the habitat module is capable of rotating at about 10 to about 15 revolutions per minute.

18. The spacecraft according to claim 15, further comprising:
at least one radiator capable of radiating waste heat from the spacecraft;
at least one solar panel capable of collecting solar energy; and
at least three attitude thrusters capable of adjusting an attitude of the habitat module.

19. The spacecraft according to claim 15, further comprising:
a docking port for docking the spacecraft to other space structures; and
a vehicle module for storing a crew escape vehicle or a planetary landing vehicle.

20. A spacecraft for traveling through space comprising:
an inflatable habitat module capable of rotating to provide an artificial gravity environment;
a propulsion module capable of propelling the spacecraft through space;
a storage module, wherein the storage module and the propulsion module are contained in a center core of the spacecraft;
at least one radiator capable of radiating waste heat from the spacecraft;
at least one solar panel capable of collecting solar energy; and
at least three attitude thrusters capable of adjusting an attitude of the habitat module.

21. The spacecraft according to claim 20, wherein:
the habitat module has an internal diameter of about 10 to about 30 feet;
the center core has a radius of about 40 to about 80 feet; and
the habitat module is capable of rotating at about 10 to about 15 revolutions per minute.

22. A spacecraft comprising:
an inflatable habitat module capable of rotating to provide an artificial gravity environment;
a propulsion module capable of propelling the spacecraft through space; and
a storage module,
wherein the propulsion module is located on a plane parallel to a circumferential plane of the habitat module.

23. The spacecraft according to claim 22, further comprising:
at least one radiator capable of discharging waste heat from the spacecraft;
at least one solar panel capable of collecting solar energy; and
at least three attitude thrusters mounted on an outer circumference of the habitat module capable of adjusting an attitude of the habitat module.

24. The spacecraft according to claim 22, further comprising:
a docking port for docking the spacecraft to other space structures; and
a vehicle module for storing a crew escape vehicle or a planetary landing vehicle.

25. The spacecraft according to claim 22, wherein:
the habitat module has an internal diameter of about 10 to about 30 feet;
the center core has a radius of about 40 to about 80 feet; and
the habitat module is capable of rotating at about 10 to about 15 revolutions per minute.

26. A method for space travel in a spacecraft comprising:
providing an artificial gravity environment by rotating a habitat module at a rotational velocity sufficient to create a gravitational force; and
propelling the spacecraft through space with a propulsion module.

27. The method according to claim 26, further comprising radiating of waste heat from the spacecraft via a radiator panel.

28. The method according to claim 26, further comprising adjusting an attitude of the habitat module with an attitude thruster.

29. The method according to claim 28, wherein at least three attitude thrusters are used to adjust the attitude of the habitat module.

30. The method according to claim 26, further comprising collecting solar energy with a solar panel disposed on the spacecraft.

31. The method according to claim 26 wherein the rotational velocity is from about 10 to about 15 revolutions per minute.
